(19) United States
(12) Patent Application Publication
(10) Pub. No.: US 2008/0108734 A1
(43) Pub. Date: May 8, 2008

(54) Ionomer pigmentation

(76) Inventors: Dennis C. Smith, Norwalk, OH (US); Jeffrey Robert Howell, AKron, OH (US); Mark A. Tyler, West Salem, OH (US)

Correspondence Address: PATENT GROUP 2N;JONES DAY, NORTH POINT, 901 LAKESIDE AVENUE, CLEVELAND, OH, 44114, US

(21) Appl. No.: 11/592,883

(22) Filed: Nov. 3, 2006

(51) Int. Cl. C08K 5/34

(52) U.S. Cl. 524/88

(57) ABSTRACT

A composition includes an ionomer resin and a copper phthalocyanine based pigment. The ionomer resin is a sodium neutralized ionomer resin, and is essentially free of zinc ions, whereby the composition has elevated resistance to weathering.

### TECHNICAL FIELD

This technology relates to the pigmentation of sodium neutralized ionomer resins with copper phthalocyanine pigments.

### BACKGROUND

Ionomers are polymeric macromolecules in which a small-but significant proportion of the constitutional units have ionizable or ionic groups, or both. Counter ions are used to stabilize the macromolecule by neutralizing the overall ionomer charge state. The use of certain pigments, such as Cu-phthalocyanine greens and blues, with neutralized ionomers can result in weathering failures such as cracking, crazing, and flaking. These failures occur quickly during accelerated weathering as simulated, e.g., under a xenon arc lamp (2500 kJ-3000 kJ), and reduce the quality of the appearance and distinctness-of-image of the polymer surface.

### SUMMARY

A composition includes an ionomer resin and a copper phthalocyanine based pigment. The ionomer resin is a sodium neutralized ionomer resin, and is essentially free of zinc ions, whereby the composition has elevated resistance to weathering.

### BRIEF DESCRIPTION OF THE DRAWINGS

FIG. 1 is a cross-sectional view of a two-layer film.

FIG. 2 is a cross-sectional view of a three-layer film.

FIG. 3 is a cross-sectional view of a four-layer film.

### DETAILED DESCRIPTION

As examples of how a person of ordinary skill in the art can make and use the claimed invention, this description presents examples of pigmented, sodium neutralized ionomer compositions that are essentially free of zinc ions and that remain stable upon weathering, and multilayer structures made in part from such pigmented, sodium neutralized ionomers. These compositions and multilayer structures are described here to meet the requirements of enablement and best mode without imposing limitations that are not recited in the claims. Ionomers neutralized with sodium ions can be pigmented with pigments such as, for example, Cu-phthalocyanine green and blue pigments such as tetrachloro and monochloro type blues (15:1-15:4); blue shade green such as PG7; yellow shade green such as PG36; PB 60; PB 76; and mixtures thereof Ionomers that are pigmented with these types of pigments are more resistant to weathering failures such as cracking, crazing, and flaking if the ionomers are neutralized with sodium ions and are essentially free of zinc ions. For example, such ionomers do not exhibit those failures under accelerated weathering simulated by exposure to a xenon arc weathering lamp at greater than about 2500 kJ per SAE J1960. Some do not exhibit such failures during accelerated weathering simulated under a xenon arc lamp at about 2750 kJ per SAE J1960, and others do not exhibit failures at about 3000 kJ per SAE J1960. Still others do not exhibit failures at about 3500 kJ per SAE J1960. This weathering stability enables a part made from such an ionomer to maintain its quality of appearance and distinctness-of-image despite exposure to the elements.

Ionomers that are essentially free of zinc ions that are useful with the claimed invention include, but are not limited to, copolymers of ethylene and α,β-ethenically unsaturated C₃-C₈ carboxylic acid; and terpolymers of ethylene, α,β-ethenically unsaturated C₃-C₈ carboxylic acid, and acrylate. The average acidic level of such ionomers prior to neutralization can be between about 9 to about 15 percent. These ionomers are neutralized or partially neutralized by sodium metal ions. The highest levels of scratch resistance and gloss for such copolymers are noted when the level of neutralization is high. The highest level mar resistance coupled with good processability for products manufactured from these copolymers is found when the copolymers are neutralized at a level between about 50 to about 90 percent. The term “essentially free of zinc ions” is intended to mean the ionomer has not had any zinc containing compounds used during synthesis or intentionally added before or after synthesis, but is meant to acknowledge that a limited amount of zinc that does not adversely impact the properties of the ionomer could be present.

Pigments compatible with the sodium neutralized, essentially zinc free ionomers include organic and inorganic copper phthalocyanine pigments. Examples of the types of pigments that can be included in the ionomers include, but are not limited to, Cu-phthalocyanine green and blue pigments such as tetrachloro and monochloro type blues (15:1-15:4), blue and yellow shade greens (PG7 and 36), PB 60, and PB 76, or mixtures thereof.

The pigments can be added to the ionomer in a mixer or extruder. A pigment carrier/dispersant aid can optionally be used. Some examples of dispersant aids are resins, waxes, and other low molecular weight carriers. Examples of resins compatible with sodium neutralized ionomers that are essentially free of zinc ions include, but are not limited to, acid copolymers, acid terpolymers, ionomers, polyethylenes, ethylene vinyl acetate, ethylene methacrylate, and mixtures thereof. When a carrier/dispersant aid is used, the carrier/dispersant aid and pigment are pre-blended to form a “pre-dispersion” that is added to the ionomer before or during mixing. The use of resins as carrier/dispersant aids is more fully described in U.S. application Ser. No. 11/155,361, filed Jun. 17, 2005, which is incorporated herein by reference.

Additional additives such as, for example, processing aids, secondary processing aids, and stabilizers can be added to the ionomers during preparation. Examples of stabilizers may include, but are not limited to, secondary phosphites, secondary phosphonites, antioxidants, UV stabilizers, and hindered amine stabilizers. Plasticizers may also be added as processing aids to reduce the viscosity of the carrier resin. Secondary processing aids include materials and compounds that aid the ability to remove parts from molds or act to improve the surface hardness of the part. Examples of secondary processing aids are fatty acid amid slip masterbatchs, including primary, secondary, and secondary-bis amides. These amides can include, but are not limited to, erucamide, behenamide, and oleyl palmitate.

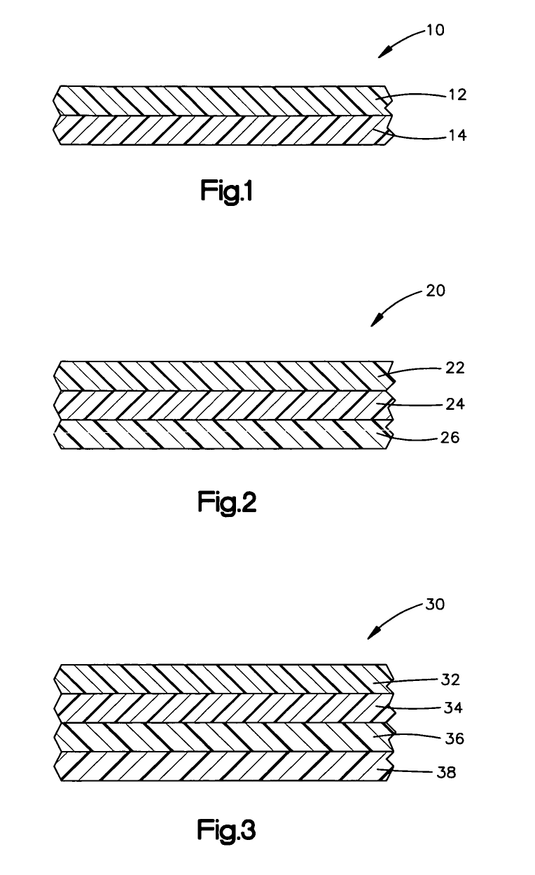

The pigmented, sodium neutralized ionomers that are essentially free of zinc ions in accordance with the claimed invention can be used in multilayer films with other polymer layers. As shown in FIG. 1, a two-layer film 10 can have a first layer 12 and a second layer 14, wherein one of the layers is a pigmented, sodium neutralized ionomer that is essentially free of zinc ions and the other layer is a polymer. The polymer layer can be an ionomer film layer or a layer of one or more other polymer materials. For example, a pigmented, sodium neutralized ionomer layer that is essentially free of zinc ions can be combined with a clear ionomer layer to form a two layer film. As shown in FIGS. 2 and 3, additional layers may be included to achieve specific physical requirements such as, for example, rigidity. The multilayer film 20 shown in FIG. 2 comprises a first layer 22, a second layer 24, and a third layer 26, wherein one of the layers is a pigmented, sodium neutralized ionomer that is essentially free of zinc ions and the other layers are polymers. The multilayer film 30 shown in FIG. 3 has a first layer 32, a second layer 34, a third layer 36, and a fourth layer 38, wherein one of the layers is a pigmented, sodium neutralized ionomer that is essentially free of zinc ions and the other layers are polymers.

These multilayer films can be thermoformed into specific shaped parts such as, for example, an automobile bumper or other exterior trim panel. Such parts can be made from multilayer films that include layers that are thick enough to provide sufficient structural stability to be used alone, or the parts can be injection molded from behind with additional polymer material to provide support.

The multilayer films can be formed by co-extrusion. The layers of a co-extruded multi-layer film can include a pigmented, sodium neutralized ionomer layer that is co-extruded with ionomer film layers or layers of other polymer materials. For example the co-extruded pigmented, sodium neutralized ionomer layer that is essentially free of zinc ions can be a second layer and a co-extruded ionomer clear layer can be a first layer. A co-extruded third layer could be another ionomer layer or another polymer material. For example, the co-extruded third layer may be a glycidyl-methacrylate modified polypropylene derivative in which the glycidyl methacrylate may be grafted onto the polypropylene or the glycidyl methacrylate modified ethylene is physically cross-linked with a copolymer of polypropylene. The co-extruded third layer could also be a chlorinated polypropylene. Such modified polypropylenes exhibit excellent adhesion to co-extruded ionomer layers and also provide stiffness to products formed from the multilayer films, for example, by thermoforming.

These co-extruded multilayer films can include any number of layers to create a desired set of physical properties. Additional co-extruded layers can include, but are not limited to, polymers such as polypropylene, polypropylene copolymer, polyethylene, polyethylene copolymer, polyamide, polyester, ABS, styrene terpolymer, and polyurethane. These additional layers can include tie layers that bind the layers on either side of a tie layer together. Examples of co-extruded layers that can act as tie layers include, but are not limited to, polymers such as maleic anhydride grafted copolymers or terpolymers, acrylate modified ionomers or terpolymers, glycidal methacrylate copolymers or terpolymers, styrene copolymers and terpolymers such as SEBS, SIS, SAN, ABS, polyester polyurethane, polyether polyurethane, amorphous polyamide, ethylene-octene, butene, hexene, and mixtures thereof.

### EXAMPLES

To evaluate the weathering of pigmented ionomers that are essentially free of zinc ions and that are neutralized using sodium ions versus pigmented ionomers containing zinc, plaques were created that were then subjected to artificial weathering.

Sodium Neutralized lonomer Plague

A plaque was created for weathering testing using Clarix® 111301-01 sodium neutralized ionomer that was essentially free of zinc ions (A. Schulman, Inc.; Akron, Ohio). First, a flush was made using phthalo blue (PB 15:1) pigment from Sun Chemical Corporation (Cincinnati, Ohio) and an acid copolymer. Then the flush was added to the sodium neutralized ionomer by mixing in an extruder. Finally, the pigmented sodium neutralized ionomer was injection molded into a plaque.

Zinc/Sodium Neutralized Ionomer Plaque

A zinc/sodium neutralized ionomer plaque was made using the same technique as the sodium neutralized plaque that was essentially free of zinc with the exception that Clarix® 311301-01 zinc/sodium neutralized ionomer was used.

Weathering

The plaques were weathered using an Atlas Ci5000 Weatherometer (ATLAS Material Testing Technology; Chicago, Ill.) using the SAE J1960 weathering standard. The pigmented zinc/sodium neutralized ionomer exhibited cracking, while the pigmented sodium neutralized ionomer that was essentially free of zinc did not show any cracking. These results demonstrate that sodium neutralized ionomer resins essentially free of zinc containing copper based phthalo pigments will withstand weathering better than zinc-sodium neutralized ionomer resins containing copper based phthalo pigments.

This written description sets forth the best mode of the invention, and describes the invention so as to enable a person skilled in the art to make and use the invention, by presenting examples of the elements recited in the claims. The patentable scope of the invention is defined by the claims, and may include other examples that occur to those skilled in the art. Such other examples, which may be available either before or after the application filing date, are intended to be within the scope of the claims if they have elements that do not differ from the literal language of the claims, or if they include equivalent elements with insubstantial differences from the literal language of the claims.

1. A composition comprising:
a copper phthalocyanine based pigment; and
a sodium neutralized ionomer resin that is essentially free of zinc ions.

2. A composition as defined in claim 1, wherein the copper phthalocyanine based pigment is a Cu-phthalocyanine green or Cu-phthalocyanine blue pigment.

3. A composition as defined in claim 2, wherein the Cu-phthalocyanine blue pigment is selected from the group consisting of 15:1, 15:2, 15:3, and 15:4.

4. A composition as defined in claim 2, wherein the Cu-phthalocyanine green pigment is either PG7 or PG36.

5. A composition as defined in claim 1, wherein the ionomer resin is a copolymer of ethylene and α,β-ethenically unsaturated C₃-C₈ carboxylic acid.

6. A composition as defined in claim 1, wherein the ionomer resin is a terpolymer of ethylene, α,β-ethenically unsaturated C₃-C₈ carboxylic acid, and acrylate.

7-9. (canceled)

10. A multilayer sheet comprising:
a clear polymer layer; and
a layer including a copper phthalocyanine based pigment and a sodium neutralized ionomer resin that is essentially free of zinc ions.

11. A multilayer sheet as defined in claim 10, wherein the copper phthalocyanine based pigment is a Cu-phthalocyanine green or Cu-phthalocyanine blue pigment.

12. A multilayer sheet as defined in claim 11, wherein the Cu-phthalocyanine blue pigment is selected from the group consisting of 15:1, 15:2, 15:3, and 15:4.

13. A multilayer sheet as defined in claim 11, wherein the Cu-phthalocyanine green pigment is either PG7 or PG36.

14. A multilayer sheet as defined in claim 10, wherein the ionomer resin is a copolymer of ethylene and α,β-ethenically unsaturated C₃-C₈ carboxylic acid.

15. A multilayer sheet as defined in claim 10, wherein the ionomer resin is a terpolymer of ethylene, α,β-ethenically unsaturated C₃-C₈ carboxylic acid, and acrylate.

16-18. (canceled)
